(19) United States
(12) Patent Application Publication
(10) Pub. No.: US 2018/0183772 A1
(43) Pub. Date: Jun. 28, 2018

(54) METHOD OF PERFORMING SECURE COMMUNICATION AND SECURE COMMUNICATION SYSTEM

(71) Applicant: Samsung Electronics Co., Ltd., Suwon-si (KR)

(72) Inventors: Sang-Hoon JEON, Hwaseong-si (KR); Kun-Yong KIM, Suwon-si (KR); Hyung-Sup KIM, Hwaseong-si (KR)

(21) Appl. No.: 15/673,657

(22) Filed: Aug. 10, 2017

(30) Foreign Application Priority Data
Dec. 22, 2016 (KR) 10-2016-0176398

(51) Int. Cl. H04L 29/06

(52) U.S. Cl. CPC H04L 63/061; H04L 63/0428; H04L 63/12

(57) ABSTRACT

In a method of performing secure communication between at least two devices, a first security session is formed between a first device and a second device while the first device operates in a secure mode. The first security session is formed by performing a handshake operation between the first device and the second device. Session information and a master key are stored into a secure element included in the first device. The session information and the master key are generated by forming the first security session. A second security session is formed between the first device and the second device while the first device operates in a normal mode. The second security session is formed without the handshake operation and by loading the session information stored in the secure element. Encoded data is exchanged by the first device and the second device through the second security session based on the master key stored in the secure element.

### CROSS-REFERENCE TO RELATED APPLICATION

This application claims the benefit of priority under 35 U.S.C. § 119 to Korean Patent Application No. 10-2016-0176398, filed on Dec. 22, 2016, in the Korean Intellectual Property Office (KIPO), the contents of which are herein incorporated by reference in their entirety.

### BACKGROUND

### 1. Technical Field

Example embodiments relate generally to communication methods, and more particularly to methods of performing secure communication between at least two devices and secure communication systems including the devices.

### 2. Description of the Related Art

To provide communications security over computer networks, various cryptographic protocols have been proposed. For example, a secure socket layer (SSL) and/or a transport layer security (TLS) can be used to provide privacy and data integrity between two communicating computer applications. Such cryptographic protocols find widespread use in applications such as web browsing, email, internet faxing, instant messaging, voice-over-IP (VoIP), etc. Researchers are conducting various research projects on techniques for improving security of end devices using cryptographic protocols.

### SUMMARY

In some exemplary embodiments, the disclosure is directed to a method of performing secure communication between a first device and a second device, the method comprising: forming a first security session between the first device and the second device while the first device operates in a secure mode, the first security session being formed by performing a handshake operation between the first device and the second device; storing session information and a master key into a secure element included in the first device, the session information and the master key being generated by forming the first security session; forming a second security session between the first device and the second device while the first device operates in a normal mode, the second security session being formed without the handshake operation and by loading the session information stored in the secure element; and exchanging, between the first device and the second device, encoded data through the second security session based on the master key stored in the secure element.

In some exemplary embodiments, the disclosure is directed to a method of performing a secure communication between a first device and a second device, the method comprising: forming a first security session between the first device and the second device while the first device operates in a secure mode, wherein the first security session is formed by performing a handshake operation between the first device and the second device; storing session information and a master key into a secure element included in the first device, wherein the session information and the master key are generated by forming the first security session; forming a second security session between the first device and the second device while the first device operates in a normal mode, wherein the second security session is formed without the handshake operation and by loading the session information stored in the secure element; and decoding, by the secure element included in the first device, encoded data received by the first device from the second device through the second security session, based on the master key stored in the secure element.

In some exemplary embodiments, the disclosure is directed to a method of performing secure communication using a first device including a processor and a secure element, the method comprising: forming a first security session between the first device and a second device while the first device operates in a secure mode, wherein forming the first security session includes generating session information and a master key; storing the session information and the master key in a storage region of the secure element included in the first device; forming a second security session between the first device and the second device while the first device operates in a normal mode, wherein forming the second security session includes retrieving by the processor the session information stored in the storage region of the secure element; encoding, by the secure element, data based on the master key stored in the secure element; and transmitting, from the first device to the second device, the data encoded by the secure element through the second security session.

### BRIEF DESCRIPTION OF THE DRAWINGS

Illustrative, non-limiting example embodiments will be more clearly understood from the following detailed description taken in conjunction with the accompanying drawings.

FIG. 1 is a flow chart illustrating a method of performing secure communication according to example embodiments.

FIGS. 2 and 3 are block diagrams illustrating examples of a first device that performs a method of performing secure communication according to example embodiments.

FIGS. 4 and 5 are diagrams for describing a method of performing secure communication according to example embodiments.

FIG. 6 is a diagram illustrating an example of forming a first security session in the embodiment of FIG. 5.

FIG. 7 is a diagram illustrating an example of storing session information and a master key into a secure element in the embodiment of FIG. 5.

FIG. 8 is a diagram illustrating an example of forming a second security session in the embodiment of FIG. 5.

FIGS. 9 and 10 are diagrams illustrating examples of exchanging encoded data in the embodiment of FIG. 5.

FIG. 11 is a diagram for describing a method of performing secure communication according to example embodiments.

FIG. 12 is a diagram illustrating an interne of things (IoT) network system that performs a method of performing secure communication according to example embodiments.

### DETAILED DESCRIPTION OF THE EMBODIMENTS

Various example embodiments will be described more fully with reference to the accompanying drawings, in which example embodiments are shown. The present disclosure may, however, be embodied in many different forms and should not be construed as limited to the embodiments set forth herein. Like reference numerals refer to like elements throughout this application.

As used herein, the terms “channel” or “communication channel” may refer to a physical transmission medium over which data or information signals can be sent by one or more senders and received by one or more receivers. The physical transmission media can include, for example, cable pathways (e.g., wire, cable, fiber-optics, etc.) or broadcast pathways (e.g., radio, satellite, microwave, infrared, etc.). The terms “load” and “loading” may refer to the process of retrieving data and/or other information from a first (e.g., external or auxiliary) storage or memory and storing the retrieved data and/or other information in a second (e.g., main) storage or memory for further processing by a processor (e.g., a central processing unit, etc.).

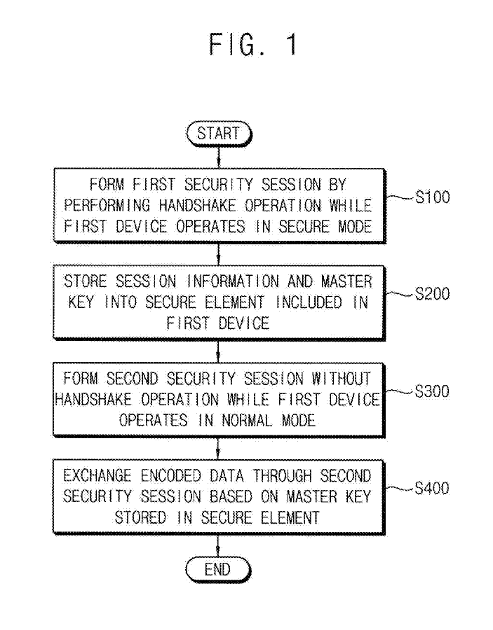

FIG. 1 is a flow chart illustrating a method of performing secure communication according to example embodiments.

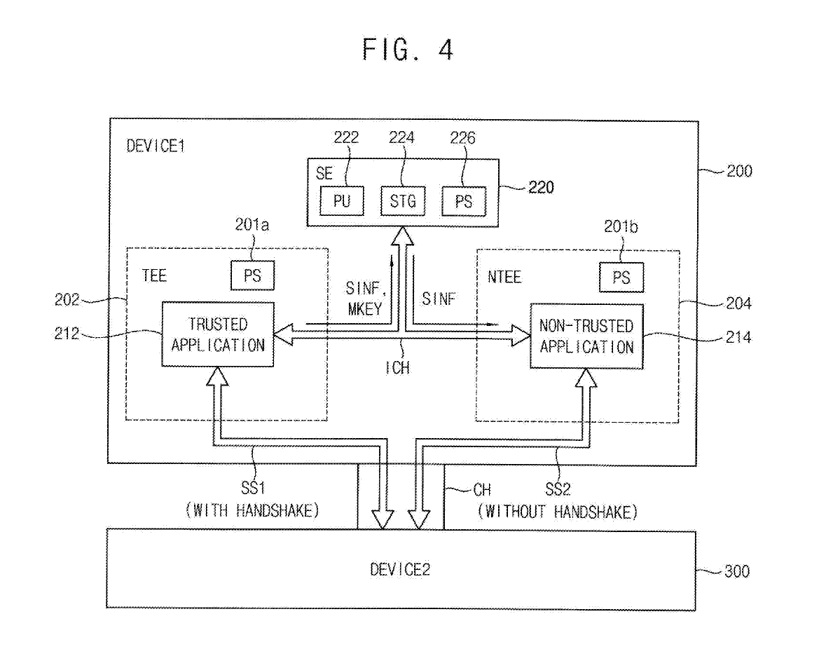

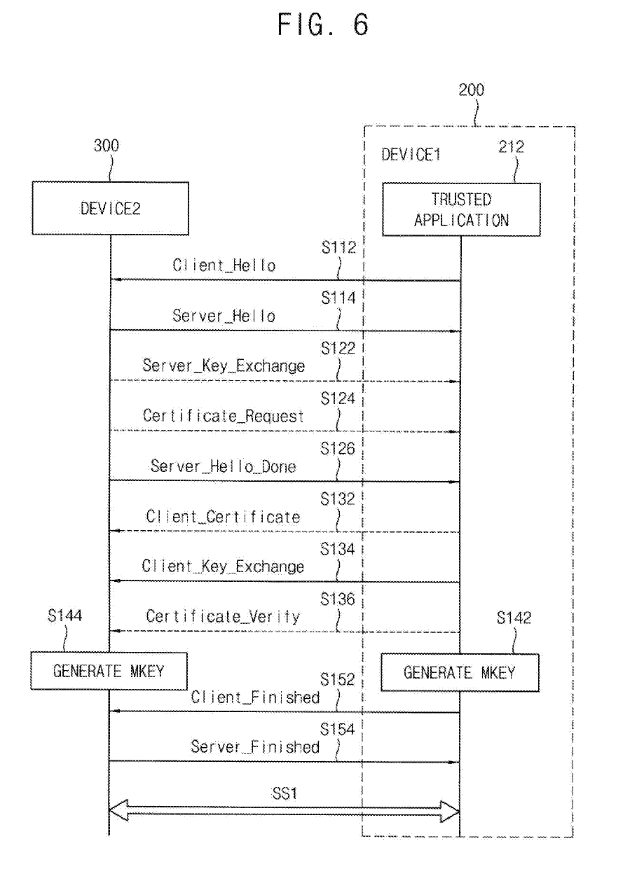

Referring to FIG. 1, in a method of performing secure communication according to example embodiments, a first security session is formed between a first device and a second device while the first device operates in a secure mode (step S100). The first security session is formed by performing a handshake operation between the first device and the second device. As will be described with reference to FIG. 4, the first device may operate in one of the secure mode and a normal mode. As used herein, the term “normal mode” may refer to a non-secure mode. The first security session may be formed in the secure mode, and may be used by the first and second devices only for the secure mode. For example, the first security session may be valid or available only in the secure mode. The handshake operation will be described with reference to FIG. 6.

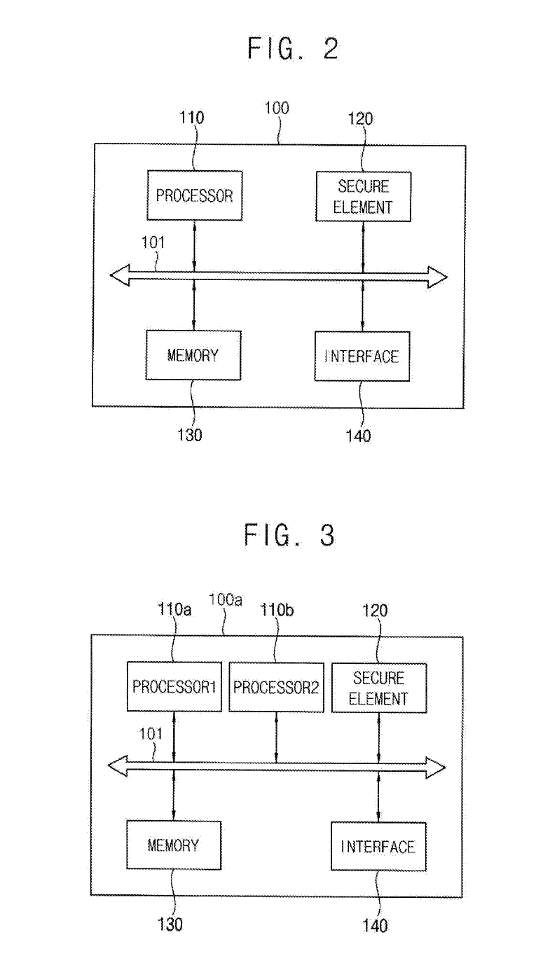

Session information and a master key (or a master secret) are stored into a secure element included in the first device (step S200). The secure element may include a memory device configured to store data and other information. The session information and the master key are generated by forming the first security session. For example, step S200 may be performed while the first device operates in the secure mode. The session information may include an internet protocol (IP) address, a port number, a certificate, or the like. The master key may be used for performing the secure communication between the first device and the second device. A configuration of the first device including the secure element will be described with reference to FIGS. 2 and 3.

A second security session is formed between the first device and the second device while the first device operates in the normal mode (step S300). The second security session is formed without the handshake operation and is formed by loading the session information stored in the secure element. For example, the session information may be brought from the secure element to a main storage of the first device (e.g., memory 130) for further processing by, for example, processor 110. The master key stored in the secure element is not loaded in step S300. The second security session may be formed in the normal mode, and may be used by the first and second devices only for the normal mode. For example, the second security session may be valid or available only in the normal mode. As will be described with reference to FIG. 4, the first security session and the second security session may not be physically distinguished from each other, but may be just logically separated from each other. For example, the first security session and the second security session may be formed based on the same session information, and then may be formed through a single channel (e.g., through the same channel).

The first device exchanges encoded data with the second device through the second security session based on the master key stored in the secure element (step S400). For example, step S400 may be performed while the first device operates in the normal mode. As described above, the master key is not loaded from the secure element while the second security session is formed. Thus, to exchange the encoded data with the second device, the first device may forward or transfer output data that is to be transmitted to the second device and/or input data that is received from the second device to the secure element. The secure element included in the first device may encode the output data, or may decode the input data.

In the method of performing the secure communication according to example embodiments, the first device may operate in one of the secure mode and the normal mode, and a security session may be formed between the first device and the second device in each of the secure mode and the normal mode. In some embodiments, for example, the two security sessions—one normal mode and one secure mode—may operate contemporaneously. A security session in the secure mode may be formed by performing the handshake operation, and the session information may be generated in the secure mode. A security session in the normal mode may be formed without the handshake operation, and may be formed based on the session information that is generated in safety in the secure mode. The secure element may be used for sharing the session information in safety in both the secure mode and the normal mode. For example, the session information may be shared between the secure mode and the normal mode in a manner that protects the session information from interception by unauthorized persons and/or devices. Accordingly, a cryptographic protocol of forming the security session between the first device and the second device may become relatively simple and light with the same security level in both the secure mode and the normal mode, and then a secure communication system performing the method may have relatively improved performance.

FIGS. 2 and 3 are block diagrams illustrating examples of a first device that performs a method of performing secure communication according to example embodiments.

Referring to FIG. 2, a first device 100 includes a processor 110 and a secure element 120. The first device 100 may further include a bus 101, a memory 130 and an interface unit 140. For convenience of illustration, some elements of the first device 100 that are unrelated to the method according to example embodiments are omitted in FIG. 2.

The processor 110 may be responsible for controlling overall operations of the first device 100. For example, the processor 110 may perform various computational functions such as particular calculations and tasks, may execute an operating system (OS) to drive the first device 100, and may execute various applications such as providing an internet browser, executing a game, displaying a video file, controlling a camera module, etc. For example, the processor 110 may be a central processing unit (CPU), a microprocessor, an application processor (AP), etc., and may be configured to perform the operations disclosed and described herein. For example, the processor 110 may include a single processor core or a plurality of processor cores.

In some example embodiments, as will be described with reference to FIG. 4, the processor 110 may be driven based on a secure OS and a normal OS. As used herein, the term “normal OS” may refer to a non-secure OS. The processor 110 and the first device 100 including the processor 110 may operate in the secure mode and may execute secure applications based on the secure OS. The processor 110 and the first device 100 including the processor 110 may operate in the normal mode and may execute normal applications based on the normal OS. The processor 110 and the first device 100 including the processor 110 may operate contemporaneously in both the secure mode and the non-secure mode.

The secure element 120 may process and/or may store secure data such as a cryptographic key, sensitive data, a sensitive code, or the like. For example, the secure element 120 may be resistant against tampering attacks, such as micro-probing, a software attack, eavesdropping, a fault generation attack, etc. The secure element 120 may include electronic circuitry or devices, and may be referred to as a security hardware, a security component, or a security module. The secure element 120 may include, for example, . . .

In some example embodiments, the processor 110 and the secure element 120 may store a pre-shared key that is used for performing the method according to example embodiments. For example, before operation of the first device by a user, the pre-shared key may be stored in one or more storage regions of the first device. In some embodiments, the pre-shared key may be pre-stored in a storage (e.g., a read-only memory (ROM)) of the first device 100 during manufacturing of the first device 100. For example, to improve security of the first device 100, the processor 110 and the secure element 120 may individually and separately store the pre-shared key into different storages (e.g., storages 201a, 201b and 226 in FIG. 4).

The memory 130 may store data and/or instructions that are processed and/or executed by the processor 110. For example, the memory 130 may store a boot image for booting the first device 100, a file system for the OS to drive the first device 100, a device driver for an external device connected to the first device 100, and/or an application executed on the first device 100. In some embodiments, the memory 130 may store session information and/or a master key brought in (e.g., loaded) from the secure element for processing and/or execution by the processor 110. The memory 130 may include at least one of a volatile memory and a nonvolatile memory. The volatile memory may include a dynamic random access memory (DRAM), a synchronous DRAM (SDRAM), a static random access memory (SRAM), etc. The nonvolatile memory may include a flash memory, a phase-change random access memory (PRAM), a resistance random access memory (RRAM), a magnetic random access memory (MRAM), a ferroelectric random access memory (FRAM), a nano floating gate memory (NFGM), a polymer random access memory (PoRAM), etc.

The interface unit 140 may communicate with an external device. The external device may be a second device that is interoperable with the first device 100 to perform the method according to example embodiments. For example, the interface unit 140 may communicate with the external device based on WiFi communication (i.e., wireless communication based on the IEEE 802.11 standards). For another example, the interface unit 140 may communicate with the external device based on a wireless mobile communication standard, such as 3G, 4G, long term evolution (LTE), etc. Alternatively, the interface unit 140 may communicate with the external device based on other wireless communication standards, such as Bluetooth, near field communication (NFC), radio-frequency identification (RFID), etc. In addition, the interface unit 140 may further include a memory interface that communicates with an external storage and/or an external memory.

The processor 110, the secure element 120, the memory 130 and the interface unit 140 may be connected to and communicate with one another via the bus 101. For example, processor 110, the secure element 120, the memory 130 and the interface unit 140 may transmit and/or receive data from/to one another via the bus 101.

Referring to FIG. 3, a first device 100a includes a first processor 110a, a second processor 110b and a secure element 120. The first device 100a may further include a bus 101, a memory 130 and an interface unit 140.

The first device 100a of FIG. 3 may be substantially the same as the first device 100 of FIG. 2, except that the first device 100a of FIG. 3 includes two processors 110a and 110b.

The first and second processors 110a and 110b may be responsible for controlling overall operations of the first device 100a. For example, the first processor 110a may be driven based on a secure OS, and the second processor 110b may be driven based on a normal OS. The first processor 110a and the first device 100a including the first processor 110a may operate in the secure mode and may execute secure applications based on the secure OS. The second processor 110b and the first device 100a including the second processor 110b may operate in the normal mode and may execute normal applications based on the normal OS. The second processor 110b may be referred to as a main processor, and the first processor 110a may be referred to as a secure processor.

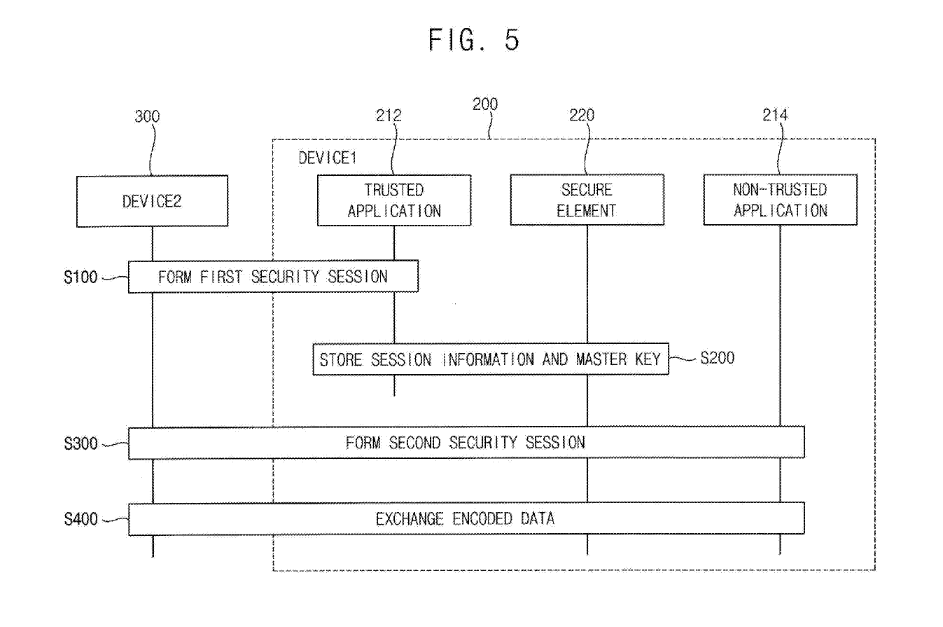

FIGS. 4 and 5 are diagrams for describing a method of performing secure communication according to example embodiments. FIG. 4 illustrates an example of software and hardware configurations in a secure communication system according to example embodiments for forming at least one security session. FIG. 5 illustrates a method of performing secure communication based on the software and hardware configurations of FIG. 4.

Referring to FIG. 4, a secure communication system according to example embodiments includes a first device 200 and a second device 300. The secure communication system may further include a channel CH that connects the first device 200 with the second device 300. For example, the channel CH may include one or more wired channels and/or wireless channels.

In some example embodiments, the first device 200 may be a client device, and the second device 300 may be a server. For example, the client device may include any computing or mobile device, such as a mobile phone, a smart phone, a tablet computer, a laptop computer, a personal digital assistants (PDA), a portable multimedia player (PMP), a digital camera, a portable game console, a music player, a camcorder, a video player, a navigation system, a wearable device, an internet of things (IoT) device, an internet of everything (IoE) device, an e-book, a virtual reality (VR) device, an augmented reality (AR) device, a robotic device, etc.

In some example embodiments, when the secure communication system is an IoT system, the first device 200 may be an IoT device, and the second device 300 may be a router. IoT devices may be classified into several groups depending on their characteristics. For example, the IoT devices may be classified into a home gadget group (e.g., group 1010 in FIG. 12), a home appliances/furniture group (e.g., group 1020 in FIG. 12), an entertainment group (e.g., group 1030 in FIG. 12), a vehicle group (e.g., group 1040 in FIG. 12), etc. The router may include a hub, a gateway, an access point (AP), etc.

For example, referring to FIG. 12, the home gadget group 1010 may include a heart rate sensor patch, a medical tool for measuring blood glucose, a lighting equipment, a hygrometer, a surveillance camera, a smart watch, a security keypad, a temperature controller, an aroma diffuser, a window blind, etc. The home appliances/furniture group 1020 may include a robot vacuum cleaner, a washing machine, a refrigerator, an air conditioner, a television (TV), a furniture item (e.g., a bed including a sensor), etc. The entertainment group 1030 may include a TV, a smart TV, a smart phone, a multimedia video system, etc. The vehicle group 1040 may include a vehicle, vehicle infrastructure (e.g., toll collection, traffic control, smart parking), the driver/user, etc.

As used herein, “IoT” may refer to a network of IoT devices that use wired and/or wireless communication. Accordingly, the IoT may be referred to as an IoT network system, a ubiquitous sensor network (USN) communication system, a machine type communication (MTC) system, a machine-oriented communication (MOC) system, a machine-to-machine (M2M) communication system, or a device-to-device (D2D) communication system. The IoT network system may use a user datagram protocol (UDP), a transmission protocol such as a transmission control protocol (TCP), an IPv6 low-power wireless personal area networks (6LoWPAN) protocol, an IPv6 internet routing protocol, a constrained application protocol (CoAP), a hypertext transfer protocol (HTTP), a message queue telemetry transport (MQTT), or an MQTT for sensors networks (MQTT-S) for exchange (or communication) of information among at least two elements therewithin.

The first device 200 may operate in one of the secure mode and the normal (non-secure) mode. In the first device 200, the secure OS may be executed in the secure mode, and then a trusted execution environment (TEE) 202 may be implemented in the secure mode. A trusted application 212 may be executed in the secure mode and the trusted execution environment 202. In addition, in the first device 200, the normal (non-secure) OS may be executed in the normal mode, and then a non-trusted execution environment (NTEE) 204 may be implemented in the normal mode. A non-trusted application 214 may be executed in the normal mode and the non-trusted execution environment 204.

For example, the secure mode and the trusted execution environment 202 may be implemented based on the TRUSTZONE® technique developed by ARM Ltd. In this example, although not illustrated in FIG. 4, the first device 200 may further include a generic interrupt controller (GIC), a trustzone protection controller (TZPC), a trustzone memory adapter (TZMA), a contents firewall (CFW), an address space protector (ASP), etc. For example, the non-trusted execution environment 204 may be referred to as a rich execution environment (REE), and the non-trusted application 214 may be referred to as a normal application or a client application.

When the first device 200 operates in the secure mode and the trusted execution environment 202 and/or when the first device 200 executes the trusted application 212, the first device 200 may communicate with the second device 300 via a first security session SS1. When the first device 200 operates in the normal mode and the non-trusted execution environment 204 and/or when the first device 200 executes the non-trusted application 214, the first device 200 may communicate with the second device 300 via a second security session SS2. As described with reference to FIG. 1, the first and second security sessions SS1 and SS2 may be logically separated from each other. The first and second security sessions SS1 and SS2 may be formed based on the same session information (e.g., based on session information SINF), and then may be formed through a single channel (e.g., through a channel CH). For example, the first and second security sessions SS1 and SS2 may be formed based on a transport layer security (TLS) scheme, and the channel CH may be referred to as a TLS channel.

The first device 200 may include a secure element (SE) 220 and an internal channel ICH. The secure element 220 may include a processing unit (PU) 222, a storage (STG) 224 and a pre-stored region (PS) 226. The processing unit 222 may handle or process secure data such as a cryptographic key, sensitive data, a sensitive code, or the like. The storage 224 may be a memory that stores the secure data. The pre-stored region 226 may be portions of memory that store a pre-shared key (e.g., may pre-store the pre-shared key in manufacturing of the first device 200). As with the pre-stored region 226, pre-stored regions 201a and 201b may be portions of memory that store the pre-shared key for each of the TEE 202 and the NTEE 204, respectively.

An internal communication of the first device 200 (e.g., a communication between a processor and the secure element 220) may be performed via the internal channel ICH. The pre-shared key may be used for performing the internal communication. For example, when the first device 200 operates in the secure mode and the trusted execution environment 202 and/or when the first device 200 executes the trusted application 212, the pre-shared key stored in the pre-stored region 201a may be used for performing the internal communication. When the first device 200 operates in the normal mode and the non-trusted execution environment 204 and/or when the first device 200 executes the non-trusted application 214, the pre-shared key stored in the pre-stored region 201b may be used for performing the internal communication. For example, the internal channel ICH may be referred to as a SE channel.

In some example embodiments, if the trusted execution environment 202 (e.g., the secure mode) and the non-trusted execution environment 204 (e.g., the normal mode) are implemented by a single processor (e.g., the processor 110 in FIG. 2), the pre-stored regions 201a and 201b may not be physically separated from each other. For example, the pre-stored regions 201a and 201b may be physically the same memory device and/or memory region, but have different logical locations (e.g., addresses, etc.). In other example embodiments, if the trusted execution environment 202 and the non-trusted execution environment 204 are implemented by different processors (e.g., the processors 110a and 110b in FIG. 3), the pre-stored regions 201a and 201b may be physically separated from each other. For example, the pre-stored regions 201a and 201b may be different memory devices and/or memory regions. In some example embodiments, the pre-stored region 226 may be physically separated from the pre-stored regions 201a and 201b.

Referring to FIGS. 4 and 5, the method of performing the secure communication according to example embodiments will be described based on the software and hardware configurations in the secure communication system according to example embodiments.

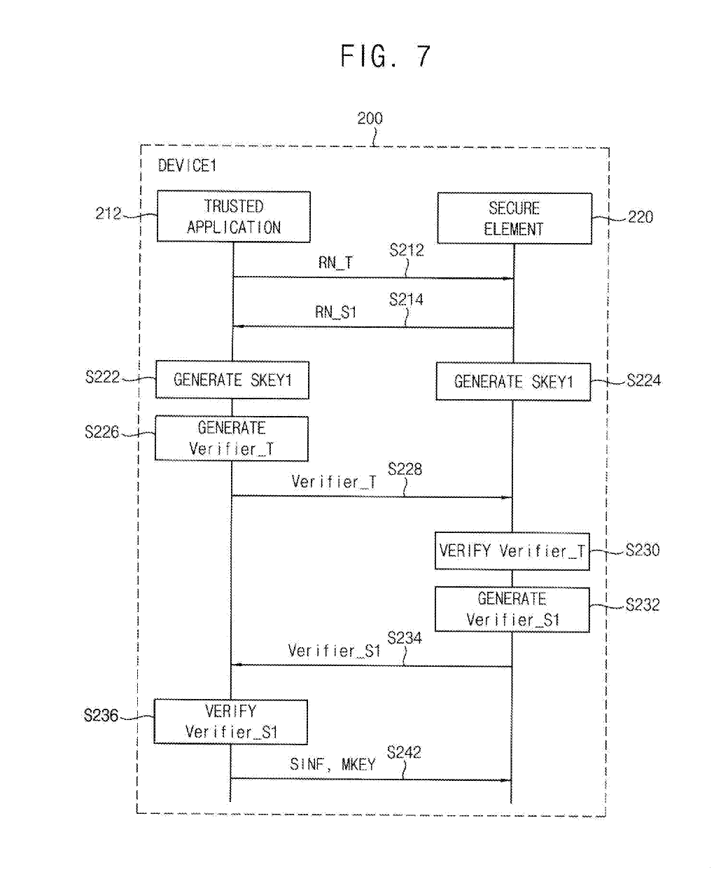

A processor (e.g., the processor 110 in FIG. 2 or the first processor 110a in FIG. 3) included in the first device 200 may execute the secure OS and the trusted application 212, and then the first device 200 and the processor may operate in the secure mode and the trusted execution environment 202. In FIG. 5, as well as in FIGS. 6 and 7, a block illustrated as the trusted application 212 may correspond to the processor that is included in the first device 200 and operates in the secure mode (e.g., the processor 110 in FIG. 2 or the first processor 110a in FIG. 3). In the secure mode, the handshake operation is performed between the processor included in the first device 200 and the second device 300, and then the first security session SS1 is formed between the processor and the second device 300 (e.g., between the first device 200 and the second device 300) (step S100).

In the secure mode, the processor transmits the session information SINF and a master key MKEY that are generated by forming the first security session SS1 to the secure element 220, and then the session information SINF and the master key MKEY are stored into the secure element 220 included in the first device 200 (step S200).

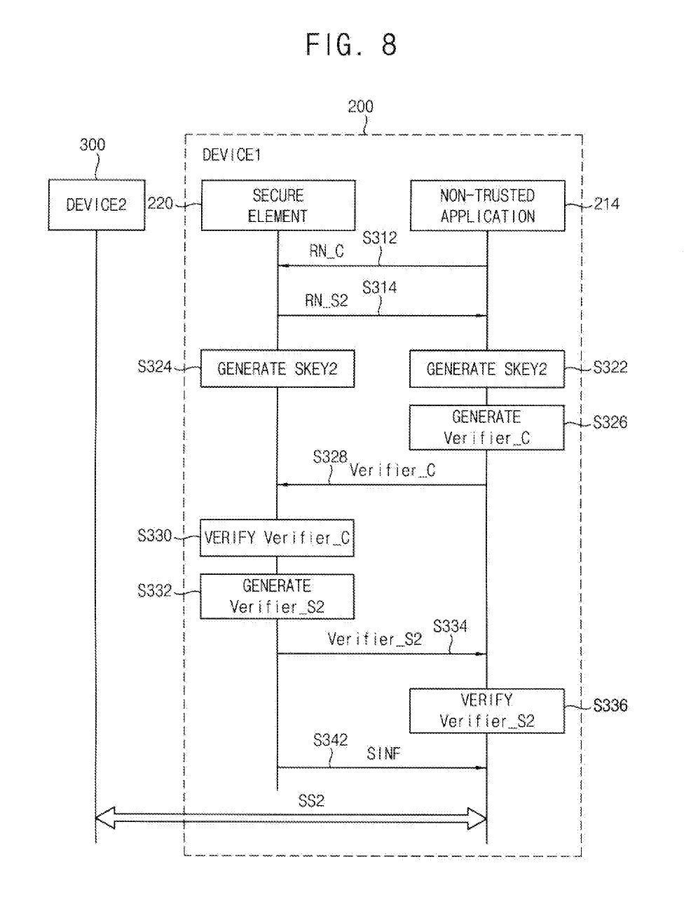

After steps S100 and S200, a processor (e.g., the processor 110 in FIG. 2 or the second processor 110b in FIG. 3) included in the first device 200 may execute the normal OS and the non-trusted application 214, and then the first device 200 and the processor may operate in the normal mode and the non-trusted execution environment 204. In FIG. 5, as well as in FIGS. 8, 9 and 10, a block illustrated as the non-trusted application 214 may correspond to the processor that is included in the first device 200 and operates in the normal mode. In the normal mode, the processor included in the first device 200 loads the session information SINF stored in the secure element 220, and then the second security session SS2 is formed between the processor and the second device 300 without the handshake operation (e.g., between the first device 200 and the second device 300) (step S300).

In the normal mode, the processor exchanges encoded data with the second device 300 through the second security session SS2 based on the master key MKEY stored in the secure element 220 (step S400).

Steps S100, S200, S300 and S400 in FIG. 5 may be substantially the same as steps S100, S200, S300 and S400 in FIG. 1, respectively.

FIG. 6 is a diagram illustrating an example of forming a first security session, as discussed in connection with step S100 of FIG. 5. In FIG. 6, each of dotted arrows represents an optional operation that is selectively performed.

Referring to FIGS. 5 and 6, to form the first security session SS1 (e.g., in step S100 of FIG. 5), the processor (e.g., the processor 110 in FIG. 2 or the first processor 110a in FIG. 3) that is included in the first device 200 and operates in the secure mode may exchange a first connection attempt message and a second connection attempt message with the second device 300. For example, the processor may transmit the first connection attempt message to the second device 300 (step S112), and the second device 300 may transmit the second connection attempt message to the processor in response to the first connection attempt message (step S114). For example, a “Client Hello” message illustrated in FIG. 6 may represent the first connection attempt message, and a “Server Hello” message illustrated in FIG. 6 may represent the second connection attempt message.

In some example embodiments, the first connection attempt message may include a protocol version that is to be performed by the first device 200, a random number of the first device 200, a session identification (ID) of the first device 200, a list of cryptographic schemes (e.g., cipher suites or compression methods) that are supported by the first device 200, etc. The second connection attempt message may include a protocol version that corresponds to the protocol version in the first connection attempt message and is agreed upon by the second device 300, a random number of the second device 300, a session ID of the second device 300, a cryptographic scheme that is included in the list of cryptographic schemes in the first connection attempt message and is selected by the second device 300, etc. In addition, each of the first and second connection attempt messages may include an IP address, a port number, etc. that are included in the session information SINF.

After the first and second connection attempt messages are exchanged, the processor that operates in the secure mode may exchange first key information and second key information with the second device 300. For example, each of the second device 300 and the processor may generate a private key. The second device 300 and the processor may generate the first key information and second key information, respectively, based on its own private key and the random number in each of the first and second connection attempt messages. The second device 300 may transmit a “Server_Key_Exchange” message including the first key information to the processor (step S122), and the processor may transmit a “Client_Key_Exchange” message including the second key information to the second device 300 (step S134). For example, the second key information may be referred to as a pre-master key.

In some example embodiments, the private key, the first key information and/or the second key information may be generated based on one of various cryptographic algorithms, such as, for example, Diffie-Hellman (DH) algorithm; data encryption standard (DES) algorithm; Rivest, Shamir & Adelman (RSA) algorithm; SHA(secure hash algorithm), etc.

In some example embodiments, if the “Server_Key_Exchange” message is omitted, the first key information may be included in a “Server_Certificate” message (not illustrated) that represents a certificate of the second device 300. In other example embodiments, if both the “Server_Key_Exchange” message and the “Server_Certificate” message are omitted, the first key information may be included in the “Server_Hello” message that represents the second connection attempt message.

In some example embodiments, after step S122 and before step S134, the second device 300 may selectively transmit a “Certificate_Request” message for requesting a certificate of the first device 200 to the processor (step S124), the second device 300 may transmit a “Server_Hello_Done” that represents all messages are successfully transmitted to the processor (step S126), or the processor may selectively transmit a “Client_Certificate” message that represents the certificate of the first device 200 to the second device 300 in response to the “Certificate_Request” message (step S132). In some example embodiments, after step S134, the processor may selectively transmit a “Certificate_Verify” message that corresponds to the “Client_Certificate” message to the second device 300 (step S136).

After the first key information and the second key information are exchanged, each of the processor of the first device 200 that operates in the secure mode and the second device 300 may generate the master key MKEY based on the first key information and the second key information (steps S142 and S144). For example, each of the processor of the first device 200 and the second device 300 may generate the master key MKEY based on the pre-master key.

After the master key MKEY is generated, the processor that operates in the secure mode may exchange a first connection completion message and a second connection completion message with the second device 300. For example, the processor may transmit the first connection completion message to the second device 300 (step S152), and the second device 300 may transmit the second connection completion message to the processor in response to the first connection completion message (step S154). For example, a “Client_Finished” message illustrated in FIG. 6 may represent the first connection completion message transmitted from the first device 200 to the second device 300, and a “Server_Finished” message illustrated in FIG. 6 may represent the second connection completion message transmitted from the second device 300 to the first device 200.

As a result, in the secure mode, the handshake operation may be performed in safety between the first device 200 and the second device 300 (e.g., between the processor that operates in the secure mode and the second device 300), and thus the first security session SS1 may be formed in safety based on the handshake operation. The session information SINF and the master key MKEY may be generated as a result of forming the first security session SS1. For example, the session information SINF may include an IP address, a port number, a certificate, or the like. The certificate included in the session information SINF may be the certificate of the first device 200.

Although not illustrated in FIG. 6, in some embodiments, before step S152, the processor may transmit a “Client_Change_Cipher_Spec” message to the second device 300. And, in some embodiments, before step S154, the second device 300 may transmit a “Server_Change_Cipher_Spec” message to the processor of the first device 200.

FIG. 7 is a diagram illustrating an example of storing session information and a master key into a secure element in FIG. 5.

Referring to FIGS. 5 and 7, to store the session information SINF and the master key MKEY that are generated by forming the first security session SS1 into the secure element 220 (e.g., in step S200), the processor (e.g., the processor 110 in FIG. 2 or the first processor 110a in FIG. 3) that is included in the first device 200 and operates in the secure mode may exchange a first random number RN_T and a second random number RN_S1 with the secure element 220. For example, the processor may transmit the first random number RN_T to the secure element 220 (step S212), and the secure element 220 may transmit the second random number RN_S1 to the processor (step S214). The first random number RN_T may be generated by the processor operating in the secure mode (e.g., executing the trusted application 212), and the second random number RN_S1 may be generated by the secure element 220.

After the first and second random numbers RN_T and RN_S1 are exchanged, the processor that operates in the secure mode and the secure element 220 may perform a verification operation based on the first random number RN_T, the second random number RN_S1 and a pre-shared key PSK.

To perform the verification operation, each of the processor and the secure element 220 may generate a session key SKEY1 based on the first random number RN_T, the second random number RN_S1 and the pre-shared key PSK (steps S222 and S224). For example, the session key SKEY1 may satisfy Equation 1.

SKEY1=SHA-256 (RN_T|RN_S1|PSK) [Equation 1]

In some example embodiments, the processor may generate the session key SKEY1 using the pre-shared key PSK that is pre-stored in the pre-stored region 201a in FIG. 4, and the secure element 220 may generate the session key SKEY1 using the pre-shared key PSK that is pre-stored in the pre-stored region 226 in FIG. 4.

The processor may generate a first verifier Verifier_T based on the session key SKEY1 (step S226), and may transmit the first verifier Verifier_T to the secure element 220 (step S228). For example, the first verifier Verifier_T may satisfy Equation 2.

Verifier_T=SHA-256 (RN_T|RN_S1|SKEY1) [Equation 2]

The secure element 220 may verify the first verifier Verifier_T (step S230). For example, the secure element 220 may verify the first verifier Verifier_T based on Equation 2. When a verification for the first verifier Verifier_T is successfully completed, the secure element 220 may generate a second verifier Verifier_S1 based on the session key SKEY1 and the first verifier Verifier_T (step S232), and may transmit the second verifier Verifier_S1 to the processor (step S234). For example, the second verifier Verifier_S1 may satisfy Equation 3.

Verifier_S1=SHA-256 (RN_T|RN_S1|SKEY1|Verifier_T) [Equation 3]

The processor may verify the second verifier Verifier_S1 (step S236). For example, the processor may verify the second verifier Verifier_S1 based on Equation 3.

When the verification operation is successfully completed, e.g., when both the verification for the first verifier Verifier_T in step S230 and a verification for the second verifier Verifier_S1 in step S236 are successfully completed, the processor that operates in the secure mode may transmit the session information SINF and the master key MKEY to the secure element 220 (step S242). Accordingly, the session information SINF and the master key MKEY that are generated in the secure mode may be stored into the secure element 220 in safety.

In some example embodiments, steps S224, S230 and S232 may be performed by the processing unit 222 in FIG. 4 that is included in the secure element 220, and the session information SINF and the master key MKEY may be stored into the storage 224 in FIG. 4 that is included in the secure element 220.

Although an example where the session key SKEY1, the first verifier Verifier__T and the second verifier Verifier_S1 are generated based on the SHA-256 algorithm is described with reference to Equations 1, 2 and 3, the session key and/or the verifiers may be generated based on one of various cryptographic algorithms according to example embodiments.

FIG. 8 is a diagram illustrating an example of forming a second security session in FIG. 5.

Referring to FIGS. 5 and 8, to form the second security session SS2 (e.g., in step S300), the processor (e.g., the processor 110 in FIG. 2 or the second processor 110b in FIG. 3) that is included in the first device 200 and operates in the normal mode may exchange a third random number RN_C and a fourth random number RN_S2 with the secure element 220. For example, the processor may transmit the third random number RN_C to the secure element 220 (step S312), and the secure element 220 may transmit the fourth random number RN_S2 to the processor (step S314). The third random number RN_C may be generated by the processor, and the fourth random number RN_S2 may be generated by the secure element 220. Steps S312 and S314 in FIG. 8 may be similar to steps S212 and S214 in FIG. 7, respectively.

After the third and fourth random numbers RN_C and RN_S2 are exchanged, the processor that operates in the normal mode and the secure element 220 may perform a verification operation based on the third random number RN_C, the fourth random number RN_S2 and the pre-shared key PSK.

To perform the verification operation, each of the processor and the secure element 220 may generate a session key SKEY2 based on the third random number RN_C, the fourth random number RN_S2 and the pre-shared key PSK (steps S322 and S324). In some example embodiments, the processor may generate the session key SKEY2 using the pre-shared key PSK that is pre-stored in the pre-stored region 201b in FIG. 4, and the secure element 220 may generate the session key SKEY2 using the pre-shared key PSK that is pre-stored in the pre-stored region 226 in FIG. 4. The processor may generate a third verifier Verifier_C based on the session key SKEY2 (step S326), and may transmit the third verifier Verifier_C to the secure element 220 (step S328). The secure element 220 may verify the third verifier Verifier_C (step S330). When a verification for the third verifier Verifier_C is successfully completed, the secure element 220 may generate a fourth verifier Verifier_S2 based on the session key SKEY2 and the third verifier Verifier_C (step S332), and may transmit the fourth verifier Verifier S2 to the processor (step S334). The processor may verify the fourth verifier Verifier S2 (step S336). As with Equations 1, 2 and 3, the generation and/or verification of the session key SKEY2, the third verifier Verifier_C and the fourth verifier Verifier S2 may satisfy Equation 4, Equation 5 and Equation 6, respectively.

SKEY2=SHA-256 (RN_C|RN_S2|PSK) [Equation 4]

Verifier_C=SHA-256 (RN_C|RN_S2|SKEY2) [Equation 5]

Verifier_S2=SHA-256 (RN_C|RN_S2|SKEY2↑Verifier_C) [Equation 6]

When the verification operation is successfully completed, e.g., when both the verification for the third verifier Verifier_C in step S330 and a verification for the fourth verifier Verifier S2 in step S336 are successfully completed, the processor that operates in the normal mode may load the session information SINF from the secure element 220 (step S342).

As a result, in the normal mode, the handshake operation may not be performed, and then the second security session SS2 may be formed between the first device 200 and the second device 300 (e.g., between the processor that operates in the normal mode and the second device 300) based on the session information SINF loaded from the secure element 220 and without the handshake operation. While the second security session SS2 is formed, the master key MKEY stored in the secure element 220 may not be exposed, leaked drained, or otherwise compromised.

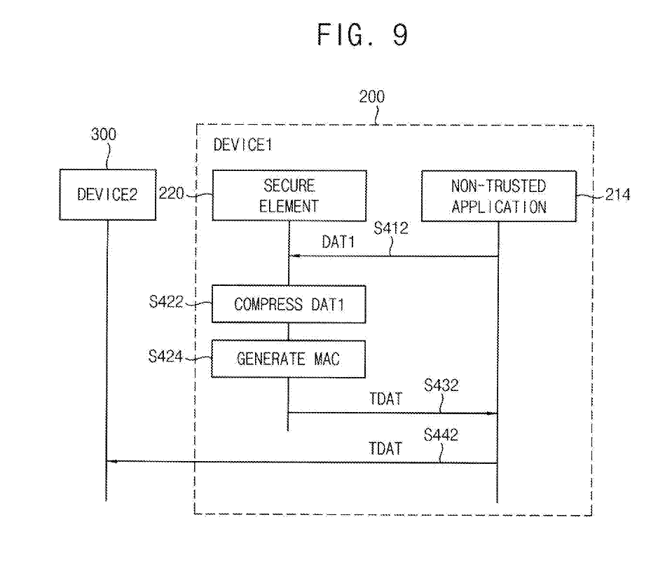

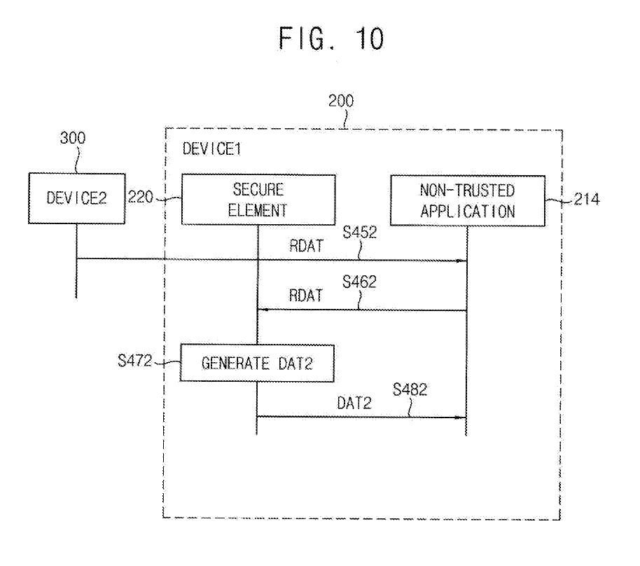

FIGS. 9 and 10 are diagrams illustrating examples of exchanging encoded data, as discussed in connection with FIG. 5.

Referring to FIGS. 5 and 9, to exchange the encoded data through the second security session SS2 (e.g., in step S400), the processor (e.g., the processor 110 in FIG. 2 or the second processor 110b in FIG. 3) that is included in the first device 200 and operates in the normal mode may transmit the encoded data to the second device 300 using the secure element 220.

Since the master key MKEY is only stored in the secure element 220, and since the processor that operates in the normal mode (e.g., non-trusted application 214) does not know the master key MKEY, the processor that operates in the normal mode may transmit first data DAT1 that is to be transmitted to the second device 300 to the secure element 220 (step S412).

After the first data DAT1 is transmitted to the secure element 220, the secure element 220 may generate second data TDAT by encoding the first data DAT1 based on the master key MKEY. For example, the second data TDAT may be encoded data. For example, the secure element 220 may compress the first data DAT1 based on the master key MKEY (step S422), and may generate a message authentication code MAC based on the master key MKEY (step S424). The secure element 220 may combine the compressed first data DAT1 with the message authentication code MAC and may encrypt the combined data to obtain the second data TDAT.

In some example embodiments, a first portion of the master key MKEY may be used for compressing the first data DAT1, and a second portion of the master key MKEY may be used for generating the message authentication code MAC. For example, the master key MKEY may be represented as a combination of a plurality of bits. A half of the plurality of bits (e.g., least significant bits (LSBs)) included in the master key MKEY may correspond to the first portion of the master key MKEY, and another half of the plurality of bits (e.g., most significant bits (MSBs)) included in the master key MKEY may correspond to the second portion of the master key MKEY.

After the second data TDAT is generated, the secure element 220 may transmit the second data TDAT to the processor that operates in the normal mode (step S432), and the processor that operates in the normal mode may transmit the second data TDAT to the second device 300 through the second security session SS2 (step S442).

Accordingly, the first data DAT1 may be encoded in safety using the secure element 220, without exposing or leaking the master key MKEY, and then the encoded data (e.g., the second data TDAT) may be transmitted to the second device 300 in safety.

Referring to FIGS. 5 and 10, to exchange the encoded data through the second security session SS2 (e.g., in step S400), the processor (e.g., the processor 110 in FIG. 2 or the second processor 110b in FIG. 3) that is included in the first device 200 and operates in the normal mode may receive the encoded data from the second device 300.

The second device 300 may transmit third data RDAT to the processor that operates in the normal mode through the second security session SS2 (step S452). The third data RDAT may be encoded data.

After the third data RDAT is received, the processor that operates in the normal mode may transmit the third data RDAT to the secure element 220 (step S462), because the master key MKEY is only stored in the secure element 220, and because the processor that operates in the normal mode does not know the master key MKEY.

After the third data RDAT is transmitted to the secure element 220, the secure element 220 may generate fourth data DAT2 by decoding the third data RDAT based on the master key MKEY (step S472). A decoding operation in step S472 may correspond to a reverse operation of the encoding operation described with reference to steps S422 and S424 in FIG. 9. For example, the secure element 220 may decrypt the third data RDAT, may divide the decrypted third data into compressed data and the message authentication code MAC, and may decompress the compressed data to obtain the fourth data DAT2.

After the fourth data DAT2 is generated, the secure element 220 may transmit the fourth data DAT2 to the processor that operates in the normal mode (step S482).

Accordingly, the third data RDAT that is received from the second device 300 may be decoded in safety using the secure element 220, without exposing or leaking the master key MKEY, and then the decoded data (e.g., the fourth data DAT2) may be obtained in safety.

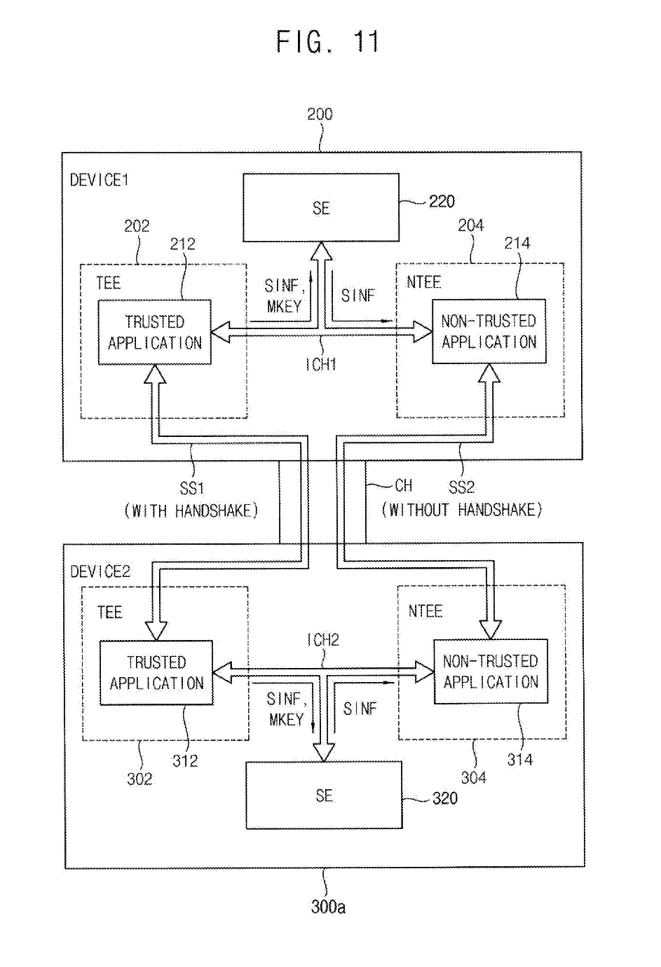

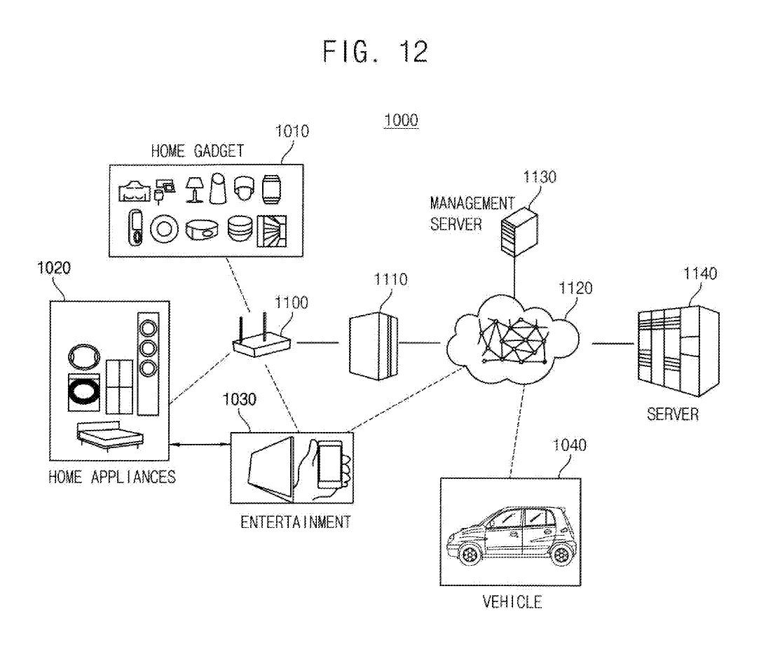

FIG. 11 is a diagram for describing a method of performing secure communication according to example embodiments. FIG. 11 illustrates another example of software and hardware configurations in a secure communication system according to example embodiments for forming at least one security session.

Referring to FIG. 11, a secure communication system according to example embodiments includes a first device 200 and a second device 300a. The secure communication system may further include a channel CH that connects the first device 200 with the second device 300a.

The secure communication system of FIG. 11 may be substantially the same as the secure communication system of FIG. 4, except that a configuration and an operation of the second device 300a in FIG. 11 are different from those of the second device 300 in FIG. 4.

In an example of FIG. 11, both the first device 200 and the second device 300a may operate in one of the secure mode and the normal mode. As with the first device 200, in the second device 300a, a secure OS may be executed in the secure mode, and then a trusted execution environment 302 may be implemented in the secure mode. A trusted application 312 may be executed in the secure mode and the trusted execution environment 302. A normal OS may be executed in the normal mode, and then a non-trusted execution environment 304 may be implemented in the normal mode. A non-trusted application 314 may be executed in the normal mode and the non-trusted execution environment 304.

When the first and second devices 200 and 300a operate in the secure mode and the trusted execution environments 202 and 302, respectively, and/or when the first and second devices 200 and 300a execute the trusted applications 212 and 312, respectively, a first security session SS1 may be formed between the first and second devices 200 and 300a. When the first and second devices 200 and 300a operate in the normal mode and the non-trusted execution environments 204 and 304, respectively, and/or when the first and second devices 200 and 300a execute the non-trusted applications 214 and 314, respectively, a second security session SS2 may be formed between the first and second devices 200 and 300a.

The second device 300a may include a secure element (SE) 320 and an internal channel ICH2. The secure element 320 and the internal channel ICH2 in the second device 300a may be substantially the same as the secure element 220 and the internal channel ICH1 in the first device 200, respectively.

Although not illustrated, operations of the second device 300a for forming the first security session SS1, storing the session information SINF and the master key MKEY into the secure element 320, forming the second security session SS2, and exchanging encoded data through the second security session SS2 may be similar to the operations of the first device 200 described with reference to FIGS. 5 through 10.

Although the example embodiments are described based on the secure communication system including two devices, the example embodiments may be applied or employed to any secure communication system that includes a plurality of devices, and the method according to example embodiments may be performed between any two devices among the plurality of devices.

As will be appreciated by those skilled in the art, the present disclosure may be embodied as a system, method, computer program product, and/or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain, or store a program for use by or in connection with an instruction execution system, apparatus, or device. For example, the computer readable medium may be a non-transitory computer readable medium.

FIG. 12 is a diagram illustrating an IoT network system that performs a method of performing secure communication according to example embodiments.

Referring to FIG. 12, an IoT network system 1000 includes a plurality of IoT devices 1010, 1020, 1030 and 1040, a hub 1100, a gateway 1110, a communication network 1120, a management server 1130 and a server 1140.

The plurality of IoT devices 1010, 1020, 1030 and 1040 may include a home gadget group 1010, a home appliances/furniture group 1020, an entertainment group 1030 and a vehicle group 1040. The plurality of IoT devices 1010, 1020, 1030 and 1040 may communicate with the management server 1130 and/or the server 1140 via at least one of the hub 1100, the gateway 1110 and the communication network 1120. The management server 1130 and the server 1140 may control and/or analyze the plurality of IoT devices 1010, 1020, 1030 and 1040, the hub 1100, the gateway 1110 and the communication network 1120.

In some example embodiments, one of the IoT devices 1010, 1020, 1030 and 1040 may correspond to the first device described with reference to FIGS. 1 through 11, and the hub 1100 may correspond to the second device described with reference to FIGS. 1 through 11. In other example embodiments, one of the IoT devices 1010, 1020, 1030 and 1040, the hub 1100 and the gateway 1110 may correspond to the first device described with reference to FIGS. 1 through 11, and one of the management server 1130 and the server 1140 may correspond to the second device described with reference to FIGS. 1 through 11. In still other example embodiments, one of the IoT devices 1010, 1020, 1030 and 1040 may correspond to the first device described with reference to FIGS. 1 through 11, and the communication network 1120 may correspond to the second device described with reference to FIGS. 1 through 11. And, in further example, embodiments, one of the IoT devices 1010, 1020, 1030 and 1040 may correspond to the first device described with reference to FIGS. 1 through 11, and one of the IoT devices 1010, 1020, 1030 and 1040 may correspond to the second device described with reference to FIGS. 1 through 11.

The present disclosure may be applied to various systems that include more than two devices performing the secure communication. For example, the present disclosure may be applied to systems including various devices such as be a mobile phone, a smart phone, a tablet computer, a laptop computer, a PDA, a PMP, a digital camera, a portable game console, a wearable device, an IoT device, a VR device, an AR device, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of performing secure communication between a first device and a second device, the method comprising:
forming a first security session between the first device and the second device while the first device operates in a secure mode, the first security session being formed by performing a handshake operation between the first device and the second device;
storing session information and a master key into a secure element included in the first device, the session information and the master key being generated by forming the first security session;
forming a second security session between the first device and the second device while the first device operates in a normal mode, the second security session being formed without the handshake operation and by loading the session information stored in the secure element; and
exchanging, between the first device and the second device, encoded data through the second security session based on the master key stored in the secure element.

2. The method of claim 1, wherein storing the session information and the master key into the secure element includes:
exchanging, by a processor and the secure element, a first random number and a second random number, the processor being included in the first device and operating in the secure mode;
performing, by the processor and the secure element, a verification operation based on the first random number, the second random number and a pre-shared key; and
transmitting, by the processor, the session information and the master key to the secure element when the verification operation is successfully completed.

3. The method of claim 2, wherein the pre-shared key is stored in the first device during manufacturing of the first device.

4. The method of claim 3, wherein the processor and the secure element individually store the pre-shared key.

5. The method of claim 2, wherein exchanging the first random number and the second random number includes:
transmitting, by the processor, the first random number to the secure element; and
transmitting, by the secure element, the second random number to the processor.

6. The method of claim 2, wherein performing the verification operation includes:
generating, by each of the processor and the secure element, a session key based on the first random number, the second random number and the pre-shared key;
generating, by the processor, a first verifier based on the session key to transmit the first verifier to the secure element;
verifying, by the secure element, the first verifier;
generating, by the secure element, a second verifier based on the session key and the first verifier to transmit the second verifier to the processor; and
verifying, by the processor, the second verifier.

7. The method of claim 1, wherein forming the second security session includes:
exchanging, by a processor and the secure element, a first random number and a second random number, the processor being included in the first device and operating in the normal mode;
performing, by the processor and the secure element, a verification operation based on the first random number, the second random number and a pre-shared key; and
loading, by the processor, the session information from the secure element when the verification operation is successfully completed.

8. The method of claim 1, wherein exchanging the encoded data through the second security session includes:
transmitting, by a processor, first data that is to be transmitted to the second device to the secure element, the processor being included in the first device and operating in the normal mode;
generating, by the secure element, second data by encoding the first data based on the master key, the second data being the encoded data;
transmitting, by the secure element, the second data to the processor; and
transmitting, by the processor, the second data to the second device through the second security session.

9. The method of claim 8, wherein generating the second data includes:
compressing the first data based on the master key to obtain compressed first data;
generating a message authentication code based on the master key; and
combining the compressed first data with the message authentication code to obtain the second data.

10. The method of claim 9, wherein a first portion of the master key is used for compressing the first data, and a second portion of the master key is used for generating the message authentication code.

11. The method of claim 1, wherein exchanging the encoded data through the second security session includes:
receiving, by a processor, first data from the second device through the second security session, the processor being included in the first device and operating in the normal mode, the first data being the encoded data;
transmitting, by the processor, the first data to the secure element;
generating, by the secure element, second data by decoding the first data based on the master key; and
transmitting, by the secure element, the second data to the processor.

12. The method of claim 1, wherein forming the first security session includes:
exchanging, by a processor and the second device, a first connection attempt message and a second connection attempt message, the processor being included in the first device and operating in the secure mode;
exchanging, by the processor and the second device, first key information and second key information;
generating, by each of the processor and the second device, the master key based on the first key information and the second key information; and
exchanging, by the processor and the second device, a first connection completion message and a second connection completion message.

13. The method of claim 1, wherein the second device operates in one of the secure mode and the normal mode, and
wherein the first security session is formed while the second device operates in the secure mode, and the second security session is formed while the second device operates in the secure mode.

14. A method of performing a secure communication between a first device and a second device, the method comprising:
forming a first security session between the first device and the second device while the first device operates in a secure mode, wherein the first security session is formed by performing a handshake operation between the first device and the second device;
storing session information and a master key into a secure element included in the first device, wherein the session information and the master key are generated by forming the first security session;
forming a second security session between the first device and the second device while the first device operates in a normal mode, wherein the second security session is formed without the handshake operation and by loading the session information stored in the secure element; and
decoding, by the secure element included in the first device, encoded data received by the first device from the second device through the second security session, based on the master key stored in the secure element.

15. The method of claim 14, wherein the first device is a client device, and the second device is a server.

16. A method of performing secure communication using a first device including a processor and a secure element, the method comprising:
forming a first security session between the first device and a second device while the first device operates in a secure mode, wherein forming the first security session includes generating session information and a master key;
storing the session information and the master key in a storage region of the secure element included in the first device;
forming a second security session between the first device and the second device while the first device operates in a normal mode, wherein forming the second security session includes retrieving by the processor the session information stored in the storage region of the secure element;
encoding, by the secure element, data based on the master key stored in the secure element; and
transmitting, from the first device to the second device, the data encoded by the secure element through the second security session.

17. The method of claim 16, wherein storing the session information and the master key into the secure element includes:
exchanging, by the secure element and the processor of the first device operating in the secure mode, a first random number and a second random number;
performing, by the secure element and the processor of the first device, a verification operation based on the first random number, the second random number, and a pre-shared key; and
transmitting, by the processor, the session information and the master key to the secure element when the verification operation is successfully completed.

18. The method of claim 17, wherein exchanging the first random number and the second random number includes:
transmitting, by the processor, the first random number to the secure element; and
transmitting, by the secure element, the second random number to the processor.

19. The method of claim 17, wherein performing the verification operation includes:
generating, by each of the processor and the secure element, a session key based on the first random number, the second random number, and the pre-shared key;
generating, by the processor, a first verifier based on the session key to transmit the first verifier to the secure element;
verifying, by the secure element, the first verifier received from the processor;
generating, by the secure element, a second verifier based on the session key and the first verifier to transmit the second verifier to the processor; and
verifying, by the processor, the second verifier received from the secure element.

20. The method of claim 16, wherein forming the second security session includes:
exchanging, by the secure element and the processor while the processor operates in the normal mode, a first random number and a second random number;
performing, by the secure element and the processor, a verification operation based on the first random number, the second random number, and a pre-shared key; and
retrieving, by the processor, the session information stored in the secure element when the verification operation is successfully completed.
